(19) United States
(12) Patent Application Publication
(10) Pub. No.: US 2026/0180442 A1
(43) Pub. Date: Jun. 25, 2026

(54) Method for Controlling an On-Board Power Supply System for a Motor Vehicle, On-Board Power Supply System and Motor Vehicle

(71) Applicant: Bayerische Motoren Werke Aktiengesellschaft, Muenchen (DE)

(72) Inventors: Xavier ANZUELA RECASENS, Muenchen (DE); Marcel FENKART, Starnberg (DE); Joachim FROESCHL, Herrsching (DE); Juergen GEBERT, Moosburg (DE); Maximilian HASE, Muenchen (DE); André SCHMITZ, Muenchen (DE)

(21) Appl. No.: 18/712,878

(22) PCT Filed: Nov. 10, 2022
(86) PCT No.: PCT/EP2022/081482

§ 371 Date: May 23, 2024

(30) Foreign Application Priority Data
Dec. 1, 2021 (DE) 10 2021 131 516.6

(51) Int. Cl. H02M 3/158; B60L 58/12; B60R 16/033

(52) U.S. Cl. CPC H02M 3/158; B60L 58/12; B60R 16/033

(57) ABSTRACT

An on-board power supply system for a motor vehicle includes a high-voltage network with a high-voltage energy storage device, a main converter for converting the high-voltage into a predetermined low-voltage in the low-voltage voltage system for supplying voltage to low-voltage consumers, a battery management system, and a bypass converter assembly. The bypass converter assembly transfers a specific maximum permissible amount of energy from the high-voltage network to the low-voltage network during a parking phase of the motor vehicle.

### BACKGROUND AND SUMMARY

The invention relates to an on-board power supply system for a motor vehicle, which on-board power supply system has a high-voltage energy store for providing a high-voltage network for supplying voltage to one or more high-voltage loads, a main converter for converting the high voltage present in the high-voltage network into a predetermined low voltage present in the low-voltage network for supplying voltage to one or more low-voltage loads, and a battery management system. Moreover, the invention relates to a method for controlling such an on-board power supply system and to a motor vehicle having such an on-board power supply system.

Such on-board power supply systems are known and are usually part of electric or hybrid vehicles having a traction store, which forms the high-voltage energy store, and an on-board power supply, which forms the low-voltage network and provides a low voltage, for example 12 V, or is operated at a low voltage. A low-voltage on-board power supply battery is usually provided as the voltage source for the low-voltage network.

Fundamentally, the problem is that energy consumption in a parked motor vehicle results in the low-voltage on-board power supply battery being discharged. Consequently, this battery has to be dimensioned large enough to ensure a reliable supply of voltage for a particular period of time.

Furthermore, it is known practice to use the high-voltage energy store as the voltage source for the low-voltage network when a motor vehicle is in the parking phase or is stationary. In this situation, however, there is the risk that the high-voltage energy store will become impermissibly deep-discharged and its performance will thus be adversely affected.

An object of the invention is to provide an on-board power supply system for a motor vehicle, which on-board power supply system ensures a reliable supply of voltage over a particularly long period of time during the parking phase of the motor vehicle. Another object of the invention is also to provide a method for operating such an on-board power supply system.

These objects are achieved by a method for controlling an on-board power supply system for a motor vehicle, which on-board power supply system has a high-voltage energy store for providing a high-voltage network for supplying voltage to one or more high-voltage loads, a main converter for converting the high voltage present in the high-voltage network into a predetermined low voltage present in the low-voltage network for supplying voltage to one or more low-voltage loads, a battery management system and a bypass converter assembly. In this case, the bypass converter assembly is configured to introduce a predetermined amount of energy from the high-voltage network into the low-voltage network during a parking phase of the motor vehicle. The method comprises the following steps:
a) aggregating the amount of energy which is introduced into the low-voltage network via the bypass converter assembly in a parking phase of the motor vehicle, and
b) switching off the bypass converter assembly if the aggregated amount of energy exceeds a particular, maximum permissible amount of energy which is permitted to be drawn from the high-voltage energy store in a parking phase of the motor vehicle.

In the context of the invention, the parking phase of the motor vehicle is in particular a phase in which the motor vehicle is not being actively operated and is parked. This state can further be defined in that the ignition of the motor vehicle has been deactivated, in that a timer triggered upon deactivation of the ignition has expired and/or in that it is detected that the driver or the vehicle occupants has/have left (and optionally also locked) the motor vehicle.

The bypass converter assembly provided separately from the main converter has the advantage that it can be specially adjusted for introducing electrical energy from the high-voltage network into the low-voltage network during the parking phase, in which the power requirement is considerably lower than during active operation of the motor vehicle, or while the motor vehicle is in motion. By virtue of the bypass converter assembly having, for example, optimum efficiency at a lower power than the main converter, the supply of voltage to the low-voltage network can be ensured much more efficiently and thus over a longer period of time than if the low-voltage network were supplied with voltage via the main converter during the parking phase. Furthermore, switching off the bypass converter assembly when the maximum permissible amount of energy is exceeded ensures that in this case the high-voltage energy store is not discharged below a defined threshold, that is to say a defined threshold value, as a result of which the high-voltage energy store is protected against impermissible deep discharge in a parking phase of the motor vehicle.

The maximum permissible amount of energy can be determined by the battery management system in this situation and transmitted to the bypass converter assembly in the parking phase of the motor vehicle before the battery management system is switched off. In this way, the maximum permissible amount of energy can be determined in a reliable manner and the energy consumption in the parking phase can be reduced by virtue of the battery management system being switched off.

In one embodiment, the maximum permissible amount of energy is determined by the battery management system on the basis of the weakest cell of the high-voltage energy store in order to reliably prevent impermissible deep discharge of the high-voltage energy store.

In addition or alternatively, the ambient temperature, the temperature of the high-voltage energy store and/or the cell aging of the cells of the high-voltage energy store can be taken into consideration during the determination of the maximum permissible amount of energy. As a result, the maximum permissible amount of energy can be chosen to be particularly large and at the same time the risk of adversely affecting the performance of the high-voltage energy store as a result of drawing the maximum permissible amount of energy can be minimized.

Furthermore, provision can be made for the bypass converter assembly to have at least two bypass converters connected in parallel. In this situation, only one part of the bypass converters is operated if the bypass power provided by that part of the bypass converters is enough to cover a present power requirement of the low-voltage network. In this way, the service life of the bypass converter assembly can be prolonged.

In this case, the individual bypass converters are in particular operated in alternating fashion such that the accumulated operating times of the individual bypass converters are equal to one another. As a result, the required service life can be shared between the bypass converters in an efficient manner and the demands on each individual bypass converter can thus be reduced. In the case of a bypass converter assembly having two bypass converters, the service life requirement of each bypass converter is halved, for example, as a result of which the bypass converter assembly is able to be produced in a particularly cost-effective manner.

Moreover, provision can be made for the bypass converter assembly to be used to introduce an amount of energy from the high-voltage network into the low-voltage network only when the parking phase of the motor vehicle has already lasted for a defined period of time, in particular of at least 24 h, or one day. This has the advantage that, during this period of time after the motor vehicle has been parked and before the bypass converter assembly has been activated, the resting energy requirement is covered from another energy source, for example a low-voltage energy store in the form of a low-voltage on-board power supply battery, and the remaining service life of the bypass converters is not reduced. Parking phases of the motor vehicle within this period of time thus do not contribute toward the accumulated operating time of the bypass converters, which means that these bypass converters have a longer service life.

In order to achieve the above-mentioned object, the invention also makes provision for an on-board power supply system for a motor vehicle, having a high-voltage network comprising a high-voltage energy store for supplying voltage to one or more high-voltage loads, a main converter for converting the high voltage present in the high-voltage network into a predetermined low voltage present in the low-voltage network for supplying voltage to one or more low-voltage loads, a battery management system and a bypass converter assembly. In this case, the bypass converter assembly is configured to inject a particular, maximum permissible amount of energy from the high-voltage network into the low-voltage network during a parking phase of the motor vehicle. As a result, the on-board power supply system has the advantages described above. In particular, owing to the bypass converter assembly, the on-board power supply system is particularly energy efficient and thus ensures a reliable supply of voltage to the low-voltage network over a particularly long period of time in the parking phase. Furthermore, the high-voltage energy store is protected against impermissible deep discharge, since the amount of energy which can be injected from the high-voltage network into the low-voltage network during a parking phase of the motor vehicle is limited to a defined value.

In one embodiment, the main converter is in the form of a DC/DC converter having a maximum power of at least 1 kW, in order to not significantly restrict the power of the motor vehicle during operation.

In addition or alternatively, the bypass converter assembly can be in the form of a DC/DC converter having a maximum power of at most 100 W, in particular of at most 50 W. In this way, the bypass converter assembly can be designed in a particularly energy-efficient manner in order to be able to electrically operate the low-voltage network by means of the maximum permissible amount of energy over a particularly long period of time in the parking phase.

According to a further embodiment, the bypass converter assembly is structurally integrated in the high-voltage energy store or in a common housing and is thus protected.

Furthermore, the bypass converter assembly can have at least two bypass converters connected in parallel, which bypass converters are configured to inject, independently of one another, an amount of energy from the high-voltage network into the low-voltage network. In this way, the bypass converter assembly can be made up of a plurality of smaller and more cost-effective bypass converters instead of one higher-performance and more expensive bypass converter.

Here, provision can be made for the bypass converters to be configured to convert bidirectionally, i.e. to inject an amount of energy both from the high-voltage network into the low-voltage network and from the low-voltage network into the high-voltage network. This has the advantage that an additional voltage source, for example a charging device, a charge retention device, a solar roof or a thermoelectric generator, can be connected to the low-voltage network in the parked state. The energy from these additional voltage sources can therefore be charged into the high-voltage energy store in an efficient manner. The high-voltage energy store is therefore also protected against deep discharge during very long parking phases of the motor vehicle. Furthermore, the energy obtained in this way can be used to extend the range of the motor vehicle if the motor vehicle has an electric drive machine which is supplied with energy by the high-voltage energy store. Moreover, it is thus also possible to minimize the number of times that the high-voltage network is connected by contactors.

In a further embodiment, the on-board power supply system is configured to connect the bypass converter assembly to the main converter in order to inject an amount of energy from the high-voltage network into the low-voltage network via the main converter and the bypass converter assembly in parallel, in particular in order to provide a power which is greater than the maximum power of the main converter. As a result, it is possible to avoid or to compensate for an energy deficit in the low-voltage network.

In order to achieve the above-mentioned object, the invention also makes provision for a motor vehicle having an on-board power supply system according to the invention having the above-mentioned advantages.

In this case, provision can be made for the motor vehicle to have an electric drive machine for electric driving operation, wherein the high-voltage energy store is configured to supply energy to the electric drive machine.

Further advantages and features are evident from the following description and from the attached drawings.

### BRIEF DESCRIPTION OF THE DRAWINGS

FIG. 1 shows a schematic illustration of a motor vehicle according to the present disclosure having an on-board power supply system according to the present disclosure,

FIG. 2 shows a schematic illustration of the on-board power supply system from FIG. 1, and

FIG. 3 shows a schematic illustration of the on-board power supply system from FIG. 1 according to a further embodiment.

### DETAILED DESCRIPTION OF THE DRAWINGS

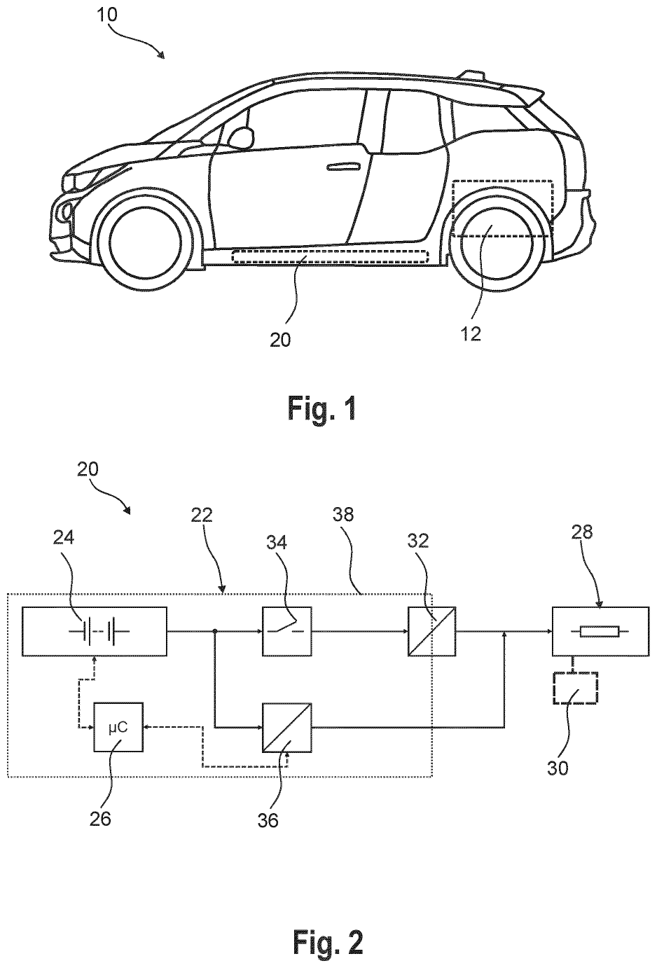

FIG. 1 shows a motor vehicle 10 having an on-board power supply system 20.

The motor vehicle 10 here has an electric drive machine 12 in the form of an electric motor which can be used to drive the motor vehicle 10 for driving operation.

For example, the motor vehicle 10 is an electric vehicle or a hybrid vehicle.

The on-board power supply system 20 (see FIG. 2) has a high-voltage network 22, having a high-voltage energy store 24 and a battery management system 26 assigned to the high-voltage energy store 24, and a low-voltage network 28.

The high-voltage energy store 24 forms a traction store of the motor vehicle 10, that is to say a store for the electrical energy required to drive the motor vehicle 10.

The low-voltage network 28 can optionally have a low-voltage energy store 30, for example in the form of a low-voltage on-board power supply battery.

The high-voltage network 22 is configured to supply a high voltage to one or more high-voltage loads, in particular a high voltage of over 220 V, for example 400 V or 800 V.

In the present exemplary embodiment, the high-voltage network 22 is configured to supply voltage to the electric drive machine 12.

The low-voltage network 28 is configured to supply a low voltage to one or more low-voltage loads, in particular a low voltage of below 150 V, for example 48 V, 24 V or 12 V.

The high-voltage network 22 further has a main converter 32 which can be electrically coupled to, or disconnected from, the high-voltage energy store 24 using a disconnecting switch 34.

The main converter 32 here is configured to convert the high voltage of the high-voltage network 22 into the low voltage of the low-voltage network 28 in order to supply the low voltage to the low-voltage loads of the low-voltage network 28.

In this context, the main converter 32 is a DC/DC converter having a maximum power of 3 to 5 kW.

In principle, the main converter 32 can be a DC/DC converter having a maximum power of at least 1 kW.

Furthermore, the main converter 32 has optimum efficiency at 1 kW.

In addition to the main converter 32, the high-voltage network 22 has a bypass converter assembly 36 which is electrically connected to the high-voltage energy store 24 and is configured to convert the high voltage of the high-voltage network 22 into the low voltage of the low-voltage network 28 independently of the main converter 32 in order to supply the low voltage to the low-voltage loads of the low-voltage network 28.

In one embodiment, the bypass converter assembly 36 is configured to convert bidirectionally.

In the present exemplary embodiment, the main converter 32 and the bypass converter assembly 36 are connected in parallel.

The bypass converter assembly 36 is in the form of a DC/DC converter having a maximum power of 100 W.

In an alternative embodiment, the bypass converter assembly 36 is in the form of a DC/DC converter having a maximum power of 50 W.

Moreover, the bypass converter assembly 36 has optimum efficiency at 1 to 2 W.

The bypass converter assembly 36 can have a single bypass converter in this instance.

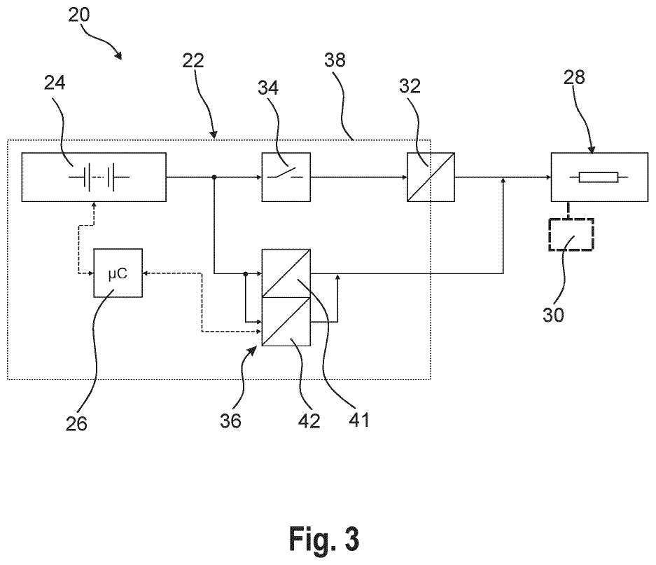

In an alternative embodiment (see FIG. 3), the bypass converter assembly 36 has two bypass converters 41, 42 connected in parallel with one another.

Here, the bypass converters 41, 42 can each have the same maximum power, for example of 50 W or 25 W in each case.

In principle, the bypass converter assembly 36 can have any number of bypass converters 41, 42 connected in parallel with one another.

Furthermore, the bypass converters 41, 42 can each have any maximum power.

The bypass converters 41, 42 and the bypass converter assembly 36 are configured in such a way that amounts of energy can each be injected from the high-voltage network 22 into the low-voltage network 28 via the individual bypass converters 41, 42, i.e. independently of one another.

In addition or alternatively, the bypass converters 41, 42 can be configured to convert bidirectionally.

Moreover, the on-board power supply system 20 is configured to inject an amount of energy from the high-voltage network 22 into the low-voltage network 28 via the main converter 32 and the bypass converter assembly 36 at the same time in order to provide a maximum power which corresponds to the sum of the maximum power of the main converter 32 and of the maximum power of the bypass converter assembly 36.

In the present exemplary embodiment, the bypass converter assembly 36 and the high-voltage energy store 24 are accommodated together with the battery management system 26 and the main converter 32 in a housing 38.

In an alternative embodiment, the bypass converter assembly 36 is integrated in the housing 38 or the high-voltage energy store 24.

Moreover, the high-voltage energy store 24 and the bypass converter assembly 36 are connected to the battery management system 26 in a signal-transmitting manner.

In order to supply low voltage to particular low-voltage loads when the motor vehicle 10 is parked and is not being actively operated, i.e. the motor vehicle 10 is in a parking phase, the low-voltage network 28 is supplied with low voltage via the bypass converter assembly 36 as described below.

If a parking phase is detected by the battery management system 26, the battery management system 26 ascertains a maximum permissible amount of energy which is permitted to be drawn from the high-voltage energy store 24 in order to introduce it into the low-voltage network 28 in the parking phase.

In this case, the battery management system 26 ascertains the maximum permissible amount of energy on the basis of the weakest cell of the high-voltage energy store 24, for example by multiplying the number of cells of the high-voltage energy store 24 by the amount of energy which is permitted to be drawn from the weakest cell of the high-voltage energy store 24 without transferring said cell to a critical state, i.e. a state in which the cell or the high-voltage energy store 24 is deep-discharged or which would adversely affect the performance of the high-voltage energy store 24 on a permanent basis.

Furthermore, during the ascertainment of the maximum permissible amount of energy, the battery management system 26 takes into consideration the ambient temperature, the temperature of the high-voltage energy store 24 and/or the cell aging of the cells of the high-voltage energy store 24, for example by multiplying the available amount of energy by an applicable factor, which is stored in a memory of the battery management system 26 for this purpose.

In a subsequent step, the battery management system 26 transmits the ascertained maximum permissible amount of energy to the bypass converter assembly 36.

The battery management system 26 is subsequently switched off in order to reduce the energy consumption in the parking phase.

In a further step, the disconnecting switch 34 is opened and the main converter 32 is thereby electrically disconnected from the high-voltage energy store 24. From this point on, the low-voltage network 28 is thus supplied with voltage by the high-voltage energy store 24 exclusively via the bypass converter assembly 36.

In this context, the bypass converter assembly 36 is configured to sum the amount of energy which is introduced into the low-voltage network 28 via the bypass converter assembly 36 in the parking phase and to switch itself off as soon as the maximum permissible amount of energy is exceeded, in order to thus prevent energy from continuing to be drawn from the high-voltage energy store 24.

In one embodiment, the low-voltage network 28 is supplied with voltage via the bypass converter assembly 36 only after the parking phase has already lasted one day, or 24 h.

In an alternative embodiment, the low-voltage network 28 can be supplied with voltage via the bypass converter assembly 36 only after a period of time in the parking phase of 36 h or 48 h.

In the meantime, the low-voltage network 28 is supplied with voltage by the low-voltage energy store 30 in this situation.

In the embodiment illustrated in FIG. 3, in which the bypass converter assembly 36 has two bypass converters 41, 42, the bypass converters 41, 42 are operated in alternating fashion so long as the power requirement of the low-voltage network 28 can be covered by one of the bypass converters 41, 42.

In this case, the operating time for each of the bypass converters 41, 42 is measured and summed in order to operate the bypass converters 41, 42 in alternating fashion in such a way that the difference between the operating times of the bypass converters 41, 42 does not exceed a defined threshold value.

If the power requirement of the low-voltage network 28 rises above the maximum power of one of the bypass converters 41, 42, then both bypass converters 41, 42 are operated in parallel in order to cover the power requirement.

In this way, the low-voltage network 28 can be supplied with voltage by the high-voltage energy store 24 in the parking phase of the motor vehicle 10 without endangering the high-voltage energy store 24 in the process.

As a result of the optimum efficiency of the bypass converter assembly 36 being adjusted for the power requirement in the parking phase, the low-voltage network 28 is supplied with voltage via the bypass converter assembly 36 in a particularly energy-efficient manner.

Furthermore, the bypass converter assembly 36 functions independently of the battery management system 26, which means that the battery management system 26 can be switched off in the parking phase.

This has the advantage that it is possible to ensure a supply of energy for a particularly long time in the parking phase, in particular of at least 6 weeks.

Moreover, the low-voltage energy store 30 can thus be designed to be particularly small or can be omitted completely.

Furthermore, the bypass converters 41, 42 are operated very gently or efficiently in this way, which means that they have a particularly long service life.

The invention is not limited to the embodiment shown. In particular, individual features of one embodiment can be combined with features of other embodiments as desired, in particular independently of the other features of the corresponding embodiments.

1-15. (canceled)

16. A method for controlling an on-board power supply system for a motor vehicle, which on-board power supply system has a high-voltage energy store for providing a high-voltage network for supplying voltage to one or more high-voltage loads, a main converter for converting the high voltage present in the high-voltage network into a predetermined low voltage present in a low-voltage network for supplying voltage to one or more low-voltage loads, a battery management system, and a bypass converter assembly, wherein the bypass converter assembly is configured to introduce a predetermined amount of energy from the high-voltage network into the low-voltage network during a parking phase of the motor vehicle, the method comprising:
aggregating the amount of energy that is introduced into the low-voltage network via the bypass converter assembly in a parking phase of the motor vehicle; and
switching off the bypass converter assembly in response to the aggregated amount of energy exceeding a maximum permissible amount of energy that is permitted to be drawn from the high-voltage energy store in a parking phase of the motor vehicle.

17. The method according to claim 16, comprising:
determining the maximum permissible amount of energy by the battery management system; and
transmitting the determined maximum permissible amount of energy to the bypass converter assembly in the parking phase of the motor vehicle before the battery management system is switched off.

18. The method according to claim 17, comprising:
determining the maximum permissible amount of energy by the battery management system on a basis of a weakest cell of the high-voltage energy store.

19. The method according to claim 17, comprising:
taking into consideration an ambient temperature, a temperature of the high-voltage energy store, and/or a cell aging of cells of the high-voltage energy store, during the determining of the maximum permissible amount of energy.

20. The method according to claim 16,
wherein the bypass converter assembly has at least two bypass converters connected in parallel, the method comprising:
operating only one part of the bypass converters in response to bypass power provided by the one part of the bypass converters being enough to cover a present power requirement of the low-voltage network; and
operating the at least two bypass converters in alternating fashion such that accumulated operating times of each of the at least two bypass converters are equal to one another.

21. The method according to claim 16, comprising:
using the bypass converter assembly to introduce an amount of energy from the high-voltage network into the low-voltage network only in response to the parking phase of the motor vehicle having already lasted for a defined period of time.

22. An on-board power supply system for a motor vehicle comprising:
a high-voltage network comprising a high-voltage energy store configured to supply voltage to one or more high-voltage loads;
a main converter configured to convert the high voltage present in the high-voltage network into a predetermined low voltage present in the low-voltage network for supplying voltage to one or more low-voltage loads;
a battery management system; and
a bypass converter assembly configured to inject a particular maximum permissible amount of energy from the high-voltage network into the low-voltage network during a parking phase of the motor vehicle.

23. The on-board power supply system according to claim 22,
wherein the main converter is in the form of a DC/DC converter having a maximum power of at least 1 kW.

24. The on-board power supply system according to claim 22,
wherein the bypass converter assembly is in the form of a DC/DC converter having a maximum power of at most 100 W.

25. The on-board power supply system according to claim 22,
wherein the bypass converter assembly is structurally integrated in the high-voltage energy store or in a common housing.

26. The on-board power supply system according to claim 22,
wherein the bypass converter assembly comprises at least two bypass converters connected in parallel, wherein the at least two bypass converters are configured to inject, independently of one another, an amount of energy from the high-voltage network into the low-voltage network.

27. The on-board power supply system according to claim 26,
wherein the bypass converters are configured to convert bidirectionally.

28. The on-board power supply system according to claim 22,
wherein the on-board power supply system is configured to connect the bypass converter assembly to the main converter in order to inject an amount of energy from the high-voltage network into the low-voltage network via the main converter and the bypass converter assembly in parallel, in order to provide a power that is greater than the maximum power of the main converter.

29. A motor vehicle comprising:
the on-board power supply system according to claim 22.

30. The motor vehicle according to claim 29, comprising:
an electric drive machine for electric driving operation,
wherein the high-voltage energy store is configured to supply energy to the electric drive machine.
